(19) United States
(12) Patent Application Publication
(10) Pub. No.: US 2026/0065248 A1
(43) Pub. Date: Mar. 5, 2026

(54) TABLE PAYMENT SYSTEM AND TABLE PAYMENT METHOD

(71) Applicant: IT Access Co., Ltd., Yokohama-shi (JP)

(72) Inventors: Shuichi MASUDA, Yokohama-shi (JP); Ten KOU, Yokohama-shi (JP)

(21) Appl. No.: 19/312,464

(22) Filed: Aug. 28, 2025

(30) Foreign Application Priority Data
Sep. 2, 2024 (JP) 2024-150609
Oct. 17, 2024 (JP) 2024-181827

(51) Int. Cl. G06Q 20/20; G06F 11/07; G06Q 20/32; G06Q 50/12

(52) U.S. Cl. CPC G06Q 20/202; G06F 11/0709; G06F 11/0772; G06F 11/079; G06Q 20/32; G06Q 50/12

(57) ABSTRACT

The table payment system comprises a parent terminal, a plurality of child terminals capable of wirelessly communicating with the parent terminal in a power saving manner, a plurality of information storage media installed on a table together with the child terminal, and a management server capable of communicating with the parent terminal and user terminal via a network and comprising a storage device. Each of sets of the child terminal and the information storage medium a is installed on each of the plurality of tables. The management server stores management information in the storage device, the management information including multiple pieces of correspondence information in which child terminal identification information, information storage medium identification information, related information are associated with each other. The management server is capable of changing an association of the correspondence information.

### CROSS-REFERENCE TO RELATED APPLICATION

The present application claims priority from Japanese applications JP2024-150609, filed on Sep. 2, 2024, and JP2024-181827, filed Oct. 17, 2024, the contents of which are hereby incorporated by reference into this application.

### TECHNICAL FIELD

The present invention relates to a table payment system and a table payment method.

### BACKGROUND ART

Various technologies have been introduced in restaurants, cafes, and other eating establishments to improve customer convenience. Among them, a table payment system is attracting attention as it allows customers to use their own smartphone or tablet to complete ordering and payment at a table without contact with employees.

Patent Document 1 (Japanese Patent Application Laid-Open No.2020-004353) discloses a cashless food ordering system (hereinafter referred to as the “conventional system”) in a restaurant.

In a restaurant where this conventional system is installed, a label on which a QR code (the QR code is a registered trademark) is printed as a two-dimensional code that records restaurant's store number information, unique desk number information for each desk, and address information of the conventional system is attached in advance to all desks/tables where customers sit. By reading the QR code (registered trademark) printed on the label using the QR code (registered trademark) reading function of his/her smartphone, the customer visiting the store can link the system on the cloud with his/her smartphone via the Internet, and the customer can then use his/her smartphone to order food and pay for the ordered food without the need for a store clerk in accordance with the procedures performed by the system.

### CITATION LIST

### Patent Literature

PTL 1: Japanese Patent Application Laid-Open No.2020-004353

### SUMMARY OF INVENTION

### Technical Problem

The inventor of the present application is considering a new table payment system with a parent terminal, a set of multiple child terminals and one or more information storage media (QR, Near Field Communication (NFC) tags, etc.). The multiple child terminals perform power-saving wireless communication with the parent terminal. In this table payment system, the set of the child terminal and one or more information storage media is installed at an arbitrary location (table), and a customer can place orders and make payments at that location. This table payment system is required to be able to use/reuse the set of the child terminal and the information storage medium at other tables and other stores other than the specific table in order to accommodate changes in table layouts and reuse at other stores.

In the conventional system, the QR code (registered trademark) stores desk number information corresponding only to a specific desk and store number information corresponding only to a specific store. The conventional system installs the QR code (registered trademark) at specific desks and specific stores indicated by the information embedded in the QR code (registered trademark), and enables orders and payments at the locations where the QR code (registered trademark) is installed.

In the conventional system, information indicating the specific desk or the specific store is embedded in the QR code (registered trademark), so the QR code (registered trademark) must be installed at that specific desk or the specific store, and the QR code (registered trademark) cannot be used/reused around other desks other than the specific desk or other stores other than the specific store.

The present invention has been made to solve the above problems. That is, one of the purposes of the present invention is to provide a table payment system and a table payment method that can easily reuse a set of the child terminal and the information storage medium.

### Solution to Problem

In order to solve the above problem, the table payment system of the present disclosure comprises:
a parent terminal;
a plurality of child terminals capable of wirelessly communicating with the parent terminal in a power saving manner;
a plurality of information storage media installed on a table together with the child terminal; and
a management server capable of communicating with the parent terminal and a user terminal via a network, the management server comprising a storage device.

The management server stores management information in the storage device, the management information including multiple pieces of correspondence information in which child terminal identification information for identifying the child terminal, information storage medium identification information for identifying the information storage medium installed on the table together with the child unit, and related information that is information related to the child terminal and the information storage medium are associated with each other; and the management server is capable of changing an association of the correspondence information.

A table payment method of the present disclosure is executed by:
a parent terminal;
a plurality of child terminals capable of wirelessly communicating with the parent terminal in a power saving manner;
a plurality of information storage media installed on a table together with the child terminal; and
a management server capable of communicating with the parent terminal and a user terminal via a network, the management server comprising a storage device.

The table payment method includes storing management information in the storage device by the management server. The management information includes multiple pieces of correspondence information in which child terminal identification information for identifying the child terminal, information storage medium identification information for identifying the information storage medium installed on the table together with the child unit, and related information that is information related to the child terminal and the information storage medium are associated with each other. An association of the correspondence information is capable of being changed by the management server.

### Advantageous Effect

According to the present invention, it is possible to easily reuse the set of the child terminal and the information storage medium. The effects described herein are not necessarily limited to any of the effects described in this disclosure.

### BRIEF DESCRIPTION OF DRAWINGS

FIG. 1 shows an example configuration of a table payment system according to the first embodiment of the present invention.

FIG. 2 shows an example of a hardware configuration of a management server.

FIG. 3A illustrates child terminal QR management information.

FIG. 3B illustrates an example of the child terminal QR management information.

FIG. 3C illustrates parent-child terminal management information.

FIG. 4 shows an example of a hardware configuration of a parent terminal.

FIG. 5 shows an example of a hardware configuration of a terminal with display.

FIG. 6A shows an example of a hardware configuration of a child terminal.

FIG. 6B shows the appearance of the child terminal and QR.

FIG. 7 shows an example of a hardware configuration of a user terminal.

FIG. 8A is a sequence diagram to explain the operation of the table payment system.

FIG. 8B is a sequence diagram to explain the operation of the table payment system.

FIG. 9A is a sequence diagram to explain the operation of the table payment system.

FIG. 9B is a sequence diagram to illustrate the operation of the table payment system.

FIG. 10A is a sequence diagram to explain the operation of the table payment system.

FIG. 10B is a sequence diagram to illustrate the operation of the table payment system.

FIG. 11 illustrates use cases.

FIG. 12 illustrates the behavior of a modifier when updating the child QR management information.

FIG. 13 illustrates the use cases.

FIG. 14 illustrates the use cases.

FIG. 15 illustrates the use cases.

FIG. 16 illustrates the use cases.

FIG. 17 shows the appearance of the child terminal and QR.

FIG. 18A shows an example configuration of a table payment system according to the second embodiment of the present invention.

FIG. 18B illustrates the operation of the table payment system according to the second embodiment.

FIG. 19 is a flowchart for explaining matching determination performed by the management server.

### DESCRIPTION OF EMBODIMENTS

Each embodiment of the present invention will be described below with reference to the drawings. In all figures of the embodiments, identical or corresponding parts may be marked with the same symbol. In the following descriptions, various types of information may be described using expressions such as “table” and “record,” but various types of information may be expressed in data structures other than these. When describing identification information, the expression “ID” is used, but other expressions are possible. In the following explanations, the processing may be explained with the device as the subject, but the subject of the processing may be a CPU or other device instead of the device.

### First Embodiment

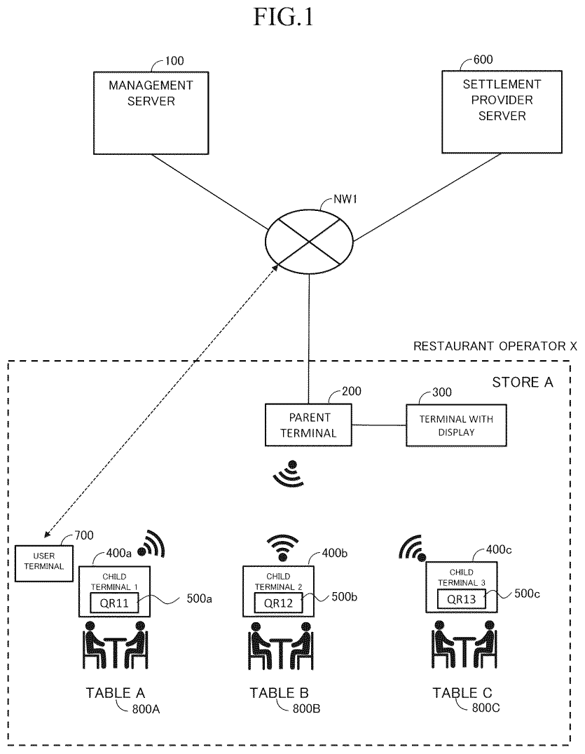

A table payment system according to the first embodiment of the present invention is described below. FIG. 1 shows an example configuration of the table payment system according to the first embodiment of the present invention. As shown in FIG. 1, the table payment system includes a management server 100, a parent terminal 200, a terminal 300 with display, a plurality of child terminals 400a through 400c, a plurality of QR 500a through QR 500c, a settlement provider server 600, and a user terminal 700. Although not shown in the figure, the table payment system may also include a terminal of an administrator who manages the table payment system.

In this example, the table payment system is installed in a store A, which is operated by a restaurant operator X. The store A is equipped with the parent terminal 200, the terminal 300 with display, a child terminal 1 400a, a child terminal 2 400b, a child terminal 3 400c, QR11 500a, QR12 500b, QR13 500c, a table A 800A, a table B 800B, and a table C 800C.

The table A 800A has the child terminal 1 400a and QR11 500a, the table B 800B has the child terminal 2 400b and QR12 500b, and the table C 800C has the child terminal 3 400c and QR13 500c. It should be noted that the child terminal 1 400a, the child terminal 2 400b, and the child terminal 3 400c may hereinafter be referred to as the “child terminal 400” when there is no need to specifically distinguish between them. QR11 500a, QR12 500b, and QR13 500c may be referred to as “QR 500” when there is no need to distinguish between them. The table A 800A, the table B 800B and the table C 800C may be referred to as the “table 800” when there is no need to distinguish between them.

The management server 100, the parent terminal 200, the settlement provider server 600, and the user terminal 700 are connected to each other through the network NW1. The parent terminal 200 and a plurality of child terminals 400a through 400c are connected to each other using low power consumption wireless technology (PAN (Personal Area Network), LPWA (Low Power Wide Area), etc.) to enable power-saving wireless communication.

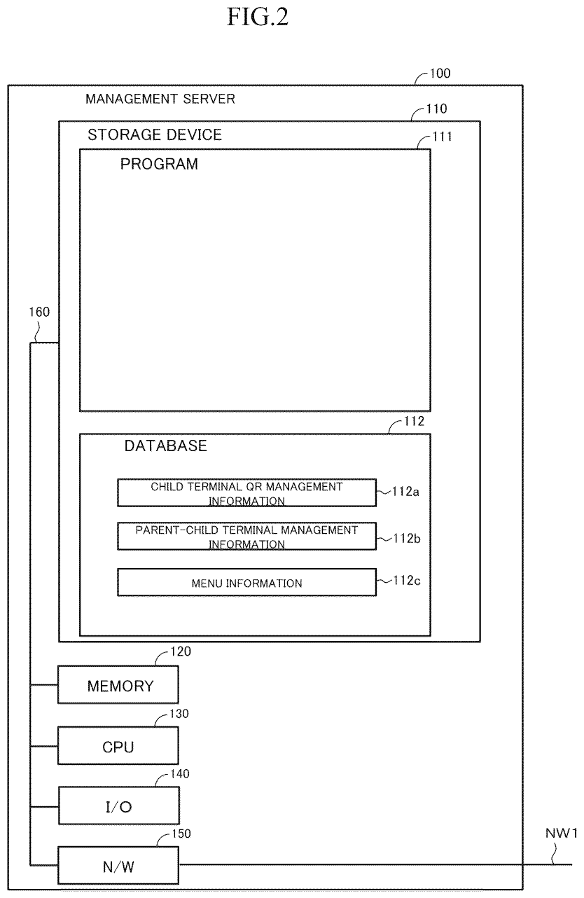

FIG. 2 shows an example of the hardware configuration of the management server 100. As shown in FIG. 2, the management server 100 has a non-volatile storage device 110 that can read and write data, a memory 120 (e.g., RAM), a CPU 130, an input/output interface 140, and a network interface 150. The CPU 130, the storage device 110, the memory 120, the input/output interface 140, and the network interface 150 are connected via a bus 160.

A device including the CPU 130, the storage device 110, the memory 120, the input/output interface 140, the network interface 150, and the bus 160 may be referred to as an “information processing device. The information processing device may be multiple information processing devices or a virtual information processing device built on a cloud. The CPU 130 may be referred to as the “computing device.

The storage device 110 holds (memorizes and stores) a program 111 and a database 112. The CPU 130 loads the program 111 stored in the storage device 110 into the memory 120. The CPU 130 executes the program 111 loaded into the memory 120 to realize various functions of the management server 100.

The database 112 includes child terminal QR management information 112a, parent-child terminal management information 112b, and menu information 112c. The child terminal QR management information 112a and/or the parent-child terminal management information 112b may be referred to as the “management information”.

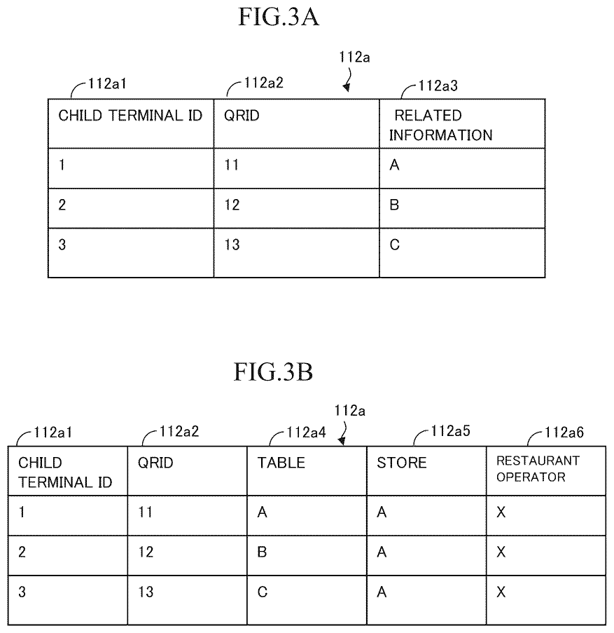

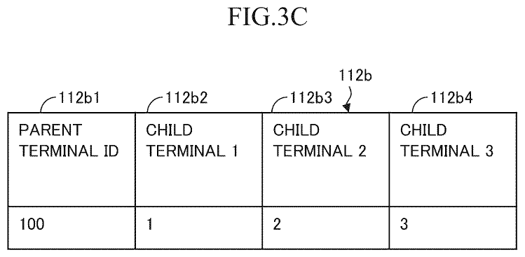

FIG. 3A illustrates the child terminal QR management information 112a. As shown in FIG. 3A, the child terminal QR management information 112a includes a child terminal ID 112a1, a QRID 112a2, and a related information 112a3 as columns (columns) that store information (values). In the child terminal QR management information 112a, the information corresponding to each column regarding the child terminal 400 and the QRID used as a set with the child terminal 400 is associated with each other and stored as row units of information (records).

Specifically, a child terminal ID (child identification information) for identifying the child terminal 400 is stored in the child terminal ID 112a1. QRID (QR identification information) for identifying QR 500 is stored in the QRID 112a2. The related information is stored in the related information 112a3. The related information is information related to the child terminal 400 and QR 500 that is associated with both the child terminal ID and QRID, and is at least one of, for example, table identification information, store identification information, and restaurant operator identification information.

The information (record) of row unit may be referred to as “correspondence information.” In the correspondence information, the identification information (child terminal ID and QRID) of each of the child terminal 400 and QR 500 installed together in the table, the store identification information indicating the store where the child terminal 400 and QR 500 are installed, the restaurant operator identification information indicating the restaurant operator who operates the store where the child terminal 400 and QR 500 are installed are associated with each other.

FIG. 3B illustrates a specific example of the child terminal QR management information 112a. The child terminal QR management information 112a in FIG. 3B includes a table 112a4, a store 112a5, and a restaurant operator 112a6 as related information 112a3. The table 112a4 stores table identification information to identify the table 800. The store 112a5 stores store identification information to identify the store. The restaurant operator 112a6 stores restaurant operator identification information for identifying the restaurant operator.

In the example in FIG. 3B, one child terminal ID and one QRID are associated with the related information (table identification information, store identification information, and restaurant operator identification information) in one record, but multiple child terminal IDs may be associated and multiple QRIDs may be associated.

FIG. 3C illustrates the parent-child terminal management information 112b. As shown in FIG. 3C, the parent-child terminal management information 112b includes a parent terminal ID 112b1, a child terminal 1 112b2, a child terminal 2 112b3, and a child terminal 3 112b4 as columns (columns) that store information (values). In the parent-child terminal management information 112b, information corresponding to each column about the parent terminal 200 and the plurality of child terminals 400 that perform power-saving wireless communication with the parent terminal 200 is associated with each other and stored as row units of information (records).

Specifically, the parent terminal ID 112b1 stores identification information (parent terminal ID) for identifying the parent terminal 200. The child terminal 1 112b2 stores identification information (child terminal ID) for identifying the child terminal 1 400a. The child terminal 2 112b3 contains identification information (child terminal ID) for identifying the child terminal 2 400b. The identification information (child terminal ID) for identifying the child terminal 3 400c is stored in the child terminal 3 112b4.

The menu information 112c stores information about the menu of food and beverage service offerings provided at the store.

Referring again to FIG. 2, the memory 120 is loaded with program 111 to be executed by the CPU 130 as described above, and data used by the CPU 130 to execute program 111 is temporarily stored.

The input/output interface 140 is an interface for connecting operating devices such as a keyboard and mouse, as well as displays and other devices. The network interface 150 is an interface for connecting the management server 100 to the network NW1.

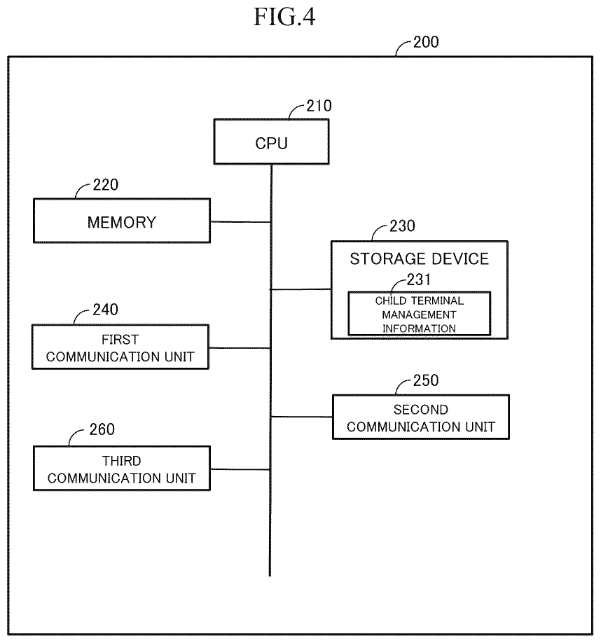

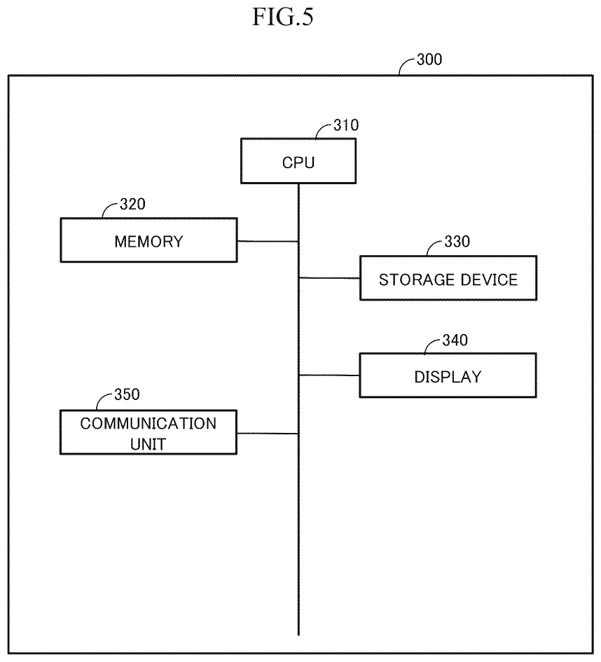

FIG. 4 shows an example of the hardware configuration of the parent terminal 200. As shown in FIG. 4, the parent terminal 200 has a CPU 210, a memory 220, a storage device 230, a first communication unit 240, a second communication unit 250, and a third communication unit 260. The CPU 210, the memory 220 (e.g., RAM), the storage device 230, the first communication unit 240, and the second communication unit 250 are connected via the bus.

The CPU 210 loads a program stored in the storage device 230 into the memory 220. The CPU 210 executes various processes by executing the program loaded into the memory 220. The storage device 230 is a non-volatile storage device capable of reading and writing data. The storage device 230 stores (stores and holds) programs and other data to control the parent terminal 200. Furthermore, the child terminal management information 231 is stored in the storage device 230. The child terminal management information 231 stores information necessary for communication with the child terminal 400. Furthermore, a parent terminal unit ID for identifying the parent terminal 200 is stored in the storage device 230.

The first communication unit 240 is a communication interface used for communication with the child terminal 400. The second communication unit 250 is a communication interface used for communication with the external management server 100 via network NW1. The second communication unit 250 is connected to the management server 100 via the network NW1. The third communication unit 260 is an interface used to connect to the terminal 300 with display.

FIG. 5 shows an example hardware configuration of the terminal 300 with display. As shown in FIG. 5, the terminal 300 with display comprises a CPU 310, a memory 320, a storage device 330, a display 340, and a communication unit 350.

The CPU 310 loads programs stored in the storage device 330 into the memory 320. The CPU 310 executes various processes by executing the programs loaded into the memory 320. The storage device 330 stores programs for controlling the terminal 300 with display and other programs. The display 340 is a display device capable of showing images. The communication unit 350 is a communication interface used for communication with the parent terminal 200.

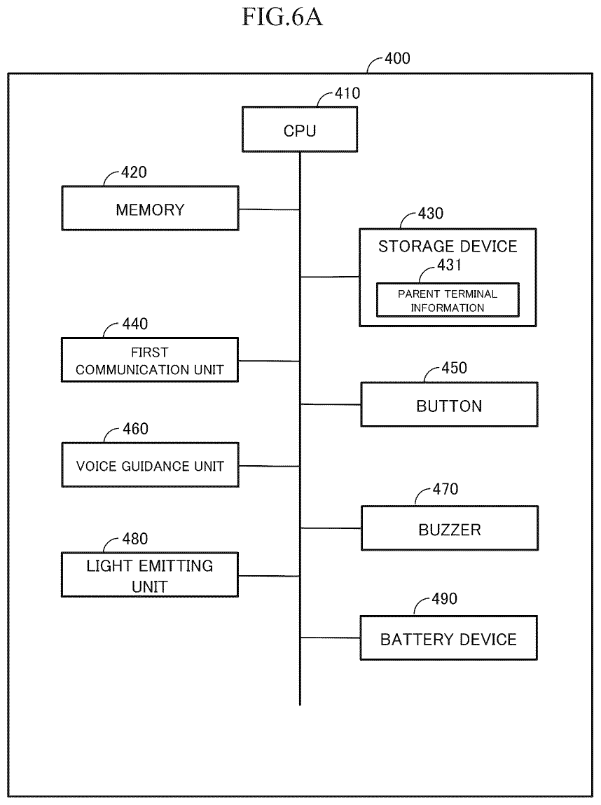

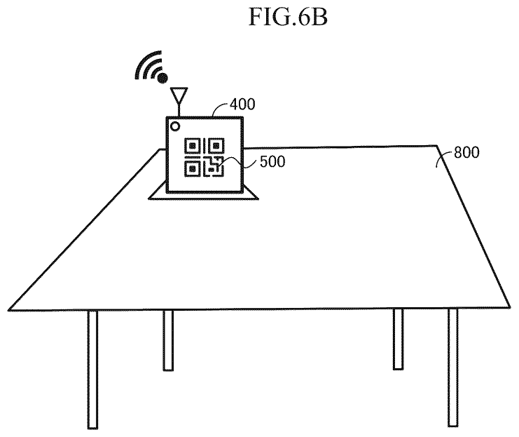

FIG. 6A shows an example hardware configuration of the child terminal 400. As shown in FIG. 6A, the child terminal 400 has a CPU 410, a memory 420, a storage device 430, a first communication unit 440, a button 450, a voice guidance unit 460, a buzzer 470, a light emitting unit 480, and a battery device 490.

The CPU 410 loads programs stored in the storage device 430 into the memory 420. The CPU 410 executes various processes by executing the programs loaded into the memory 420. The storage device 430 stores programs and other information for controlling the child terminal 400. The storage device 430 is a nonvolatile storage device capable of reading and writing data. The storage device 430 stores (stores and retains) programs and other data. The storage device 430 also stores parent terminal information 431. The parent terminal information 431 stores information necessary for communication with the parent terminal 200. The storage device 430 also stores a child terminal ID for identifying the child terminal 400.

The first communication unit 440 is a communication interface used for communication with the parent terminal 200. The button 450 is an operating device operated by the customer. The voice guidance unit 460 is a device that generates voice. The buzzer 470 is a device that generates a buzzing sound. The light emitting unit 480 is a light emitting device (e.g., LED, etc.). The battery device 490 is a device for supplying power to the child terminal 400.

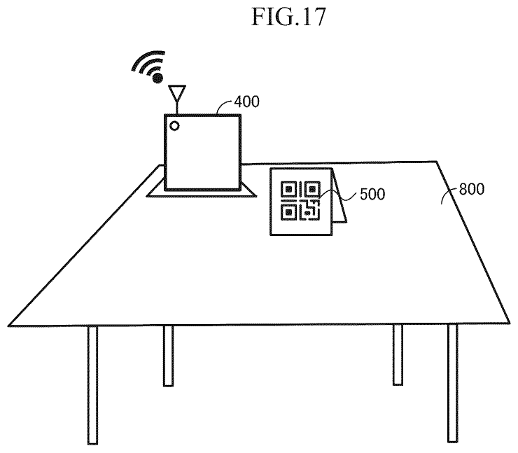

FIG. 6B shows the appearance of the child terminal 400 and QR 500. As shown in FIG. 6B, the child terminal 400 and QR 500 are installed on each the table 800 in a single unit. It should be noted that the child terminal 400 and QR 500 may be installed on each table 800 in a separate state (see FIG. 17.), as described in detail below in the second embodiment.

QR 500 is an information storage medium that stores information and allows that information to be read by a specific device (e.g., the user terminal 700, etc.). QR 500 is the information storage medium in which a code such as a QR code (registered trademark) or other two-dimensional code is printed on paper or other media. QR 500 stores information necessary to execute electronic payment, such as information indicating the location (URL (Uniform Resource Locator)) on the network NW1 of the management server 100 and the settlement provider server 600, identification information of the QR 500 (QRID), and information necessary to identify the table 800 at which the customer is seated. It should be noted that other information storage medium such as an NFC tag capable of storing information may be used as QR 500 instead of the QR code (registered trademark). The identification information of QR 500 (QRID) and the identification information of the NFC tag may be referred to as “information storage medium identification information.

The settlement provider server 600 provides electronic payment services. The same hardware configuration as the management server 100 shown in FIG. 2 can be applied to the settlement provider server 600.

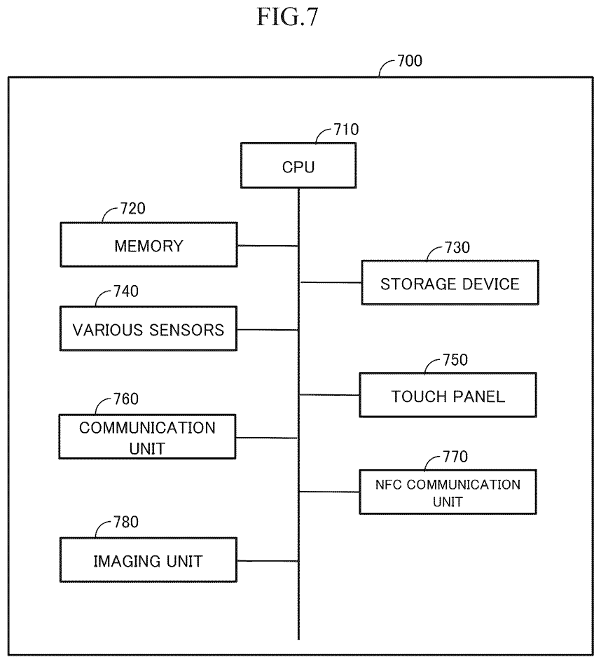

FIG. 7 shows an example hardware configuration of the user terminal 700. As shown in FIG. 7, the user terminal 700 has a CPU 710, a memory 720, a storage device 730, various sensors 740, a touch panel 750, a communication unit 760, a NFC communication unit 770, and an imaging unit 780. The CPU 710, the memory 720, the storage device 730, the various sensors 740, the touch panel 750, the communication unit 760, the NFC communication unit 770, and the imaging unit 780 are connected via a bus. An example of the user terminal 700 is a smartphone.

The CPU 710 controls the operation of the user terminal 700. The CPU 710 loads a program stored in the storage device 730 into the memory 720. The CPU 710 executes various processes by executing the program loaded into the memory 720. The storage device 730 is a nonvolatile storage device capable of reading and writing data. The storage device 730 stores (stores and holds) programs for controlling the user terminal 700 and applications for using the electronic payment service.

The various sensors 740 include a position sensor, a geomagnetic sensor, a distance sensor, an acceleration sensor, and various sensors such as a gyro sensor.

These groups of sensors make it possible to detect the position, direction, direction of movement, motion, tilt, etc. of the user terminal 700. The user terminal 700 may further be equipped with other sensors such as illumination sensors, proximity sensors, etc. The touch panel 750 is a display device that can display images and also functions as an input device.

The communication unit 760 is a communication interface that can be connected to the network NW1. The communication unit 760 communicates with external devices connected to the network NW1 under the control of the CPU 710. For example, the communication unit 760 communicates with external devices such as the management server 100 and the settlement provider server 600.

The NFC communication unit 770 performs NFC communication when in proximity to the corresponding reader/writer. The NFC communication unit 770 is equipped with a code circuit, decoding circuit, antenna, etc., respectively.

The NFC communication unit 770 reads information from NFC tags through NFC communication.

The communication unit 760 may be further equipped with other communication units such as a Bluetooth (registered trademark) communication unit and an infrared communication unit.

The imaging unit 780 is an imaging device having an image sensor such as a CCD (Charge Coupled Device) or CMOS (Complementary MOS). For example, the imaging unit 780 is used to capture images of two-dimensional codes and the like. In this case, the user terminal 700 reads information, etc. from the image of the two-dimensional code contained in the captured image.

Referring again to FIG. 1, the restaurant (store A) to which the table payment system according to the first embodiment is applied is equipped with the parent terminal 200, and sets of the child terminal 400 and QR 500. Each of the sets of the child terminal 400 and QR 500 are installed at each table 800. The management server 100 holds/has the child terminal QR management information 112a, which contains a plurality of records (multiple pieces of correspondence information) in which the child terminal ID, QRID and the related information are corresponded.

In the table payment system, the child terminal 400 and QR 500 are installed at arbitrary locations (table A 800A through the table C 800C in the example in FIG. 1), and the table identification information indicating the arbitrary location (table 800) where they are installed is associated with the child terminal 400 and QR 500 in the child terminal QR management information 112a. The table payment system allows customers to order food and beverage service offerings and pay for food and beverage services at the location (table 800) where the child terminal 400 and QR 500 are installed, without contact with employees.

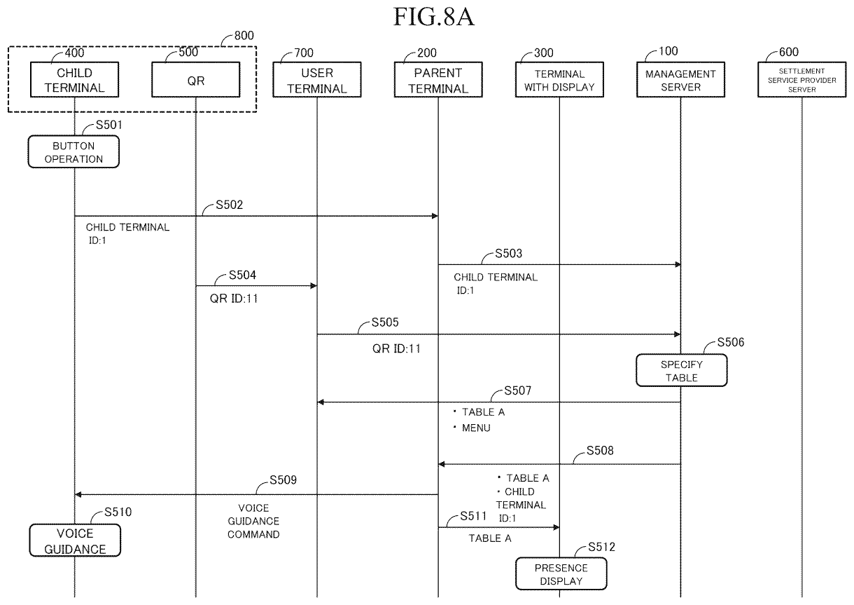

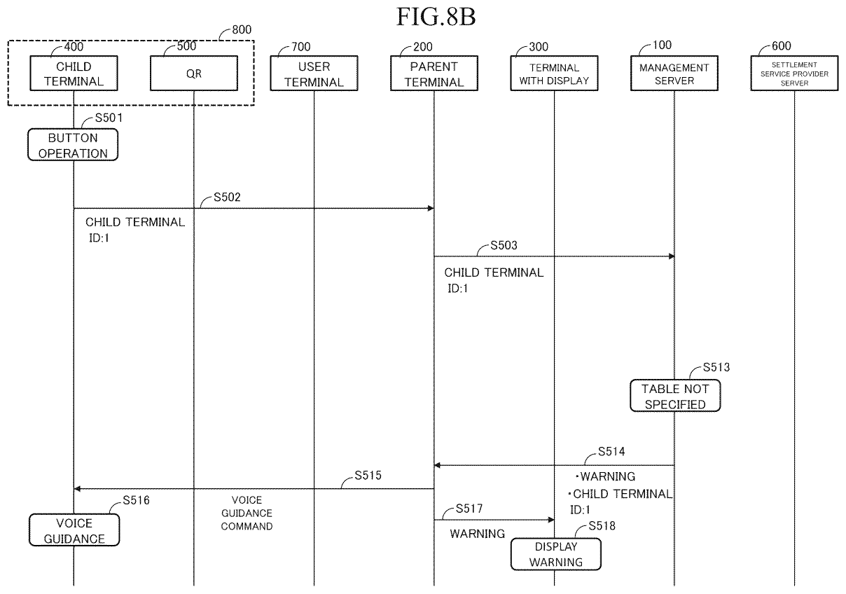

The detailed operation of the table payment system will be described below with reference to FIGS. 8A to 10B. In the table payment system, the management server 100 identifies the table 800 (the place to order and receive food and beverage service) where the customer is seated based on the child terminal ID sent from the child terminal 400, the QRID sent from the user terminal 700, and the child terminal QR management information 112a and notifies the table 800 to the employee. The employee recognizes the table 800 where the customer who is to be served food and beverage service is seated.

In the table payment system, the management server 100 sends a menu (menu information 112c) to the user terminal 700. By selecting the menu displayed on the user terminal 700, the customer can order food and beverage service offerings (food, drinks, etc.) from the menu.

In the table payment system, when the customer makes a payment, the management server 100 identifies the table 800 where the customer made the payment based on the child terminal ID sent from the child terminal 400 and the QRID sent from the user terminal 700, and the child terminal QR management information 112a, and then notifies that the table 800 has already been settled to the employee. Since the employee can recognize whether or not the table 800 at which the customer received the food and beverage service provision has been settled, the employee does not need to confirm with the customer whether or not the payment has been settled when the customer leaves the table 800.

In this way, the table payment system allows customers at the restaurant (store A) to place orders and make payments at the table 800 without contact with employees.

### <Operation>

FIG. 8A is a sequence diagram for explaining the operation of the table payment system when the customer enters the store A and is seated at the table A 800A. It should be noted that FIG. 8A describes the operation of the table payment system when the customer is seated at the table A 800A and performs an appropriate operation to place an order, whereby the table A 800A at which the customer is seated is identified by the management server 100 and the order can be placed. The appropriate operation to place an order is the operation of the child terminal 400 (button operation) and the reading of QR 500 by the user terminal.

S501: The button 450 on the child terminal 400 is operated by the customer.

S502: When the button 450 is operated, the child terminal 400 sends a child terminal ID (child terminal ID: 1) to the parent terminal 200.

S503: When the parent terminal 200 receives the child terminal ID (child terminal ID: 1) from the child terminal 400, it sends the child terminal ID to the management server 100.

S504: The user terminal 700 obtains QRID (QRID: 11) by reading QRID (QRID: 11) from QR11 500a.

S505: When the user terminal 700 obtains the QRID (QRID: 11), it sends the QRID (QRID: 11) to the management server 100.

S506: When the management server 100 receives the child terminal ID (child terminal ID: 1) and QRID (QRID: 11), it identifies the table identification information corresponding to the child terminal ID (child terminal ID: 1) and QRID (QRID: 11) by referring to the child terminal QR management information 112a. In this example, the table identification information indicating the table A 800A corresponding to both of the child terminal ID: 1 and QRID: 11 is identified.

S507: When the management server 100 identifies the table identification information, it sends the identified table identification information (table A) and the menu (menu information 112c) to the user terminal 700.

S508: The management server 100 sends the identified table identification information (table A) and the child terminal ID: 1 received at S503 to the parent terminal 200.

S509: When the parent terminal 200 receives the identified table identification information (table A) and the child terminal ID (child terminal ID: 1), it sends a voice guidance command to the child terminal 400 indicated by the child terminal ID (child terminal ID: 1).

S510: When the child terminal 400 receives the voice guidance command, it provides voice guidance by the voice guidance unit 460. An example of the voice guidance is “Thank you for visiting our store. Please start ordering.” It should be noted that the child terminal 400 may generate a buzzing sound with the buzzer 470 or emit light with the light emitting unit 480, together with or instead of the voice guidance. A command sent in this case may be referred to as a “guidance command.

S511: The parent terminal 200 sends the identified table identification information (table A) to the terminal 300 with display.

S512: When the terminal 300 with display receives the identified table identification information (table A), it displays information indicating that a customer is present at the identified table identification information (table A) on the display 340. By checking the display 340, the employee can recognize that the customer is present at the table 800 (table A 800A).

FIG. 8B is a sequence diagram to explain the operation of the table payment system when the customer enters the store A and is seated at the table A 800A. Note that FIG. 8B describes the operation of the table payment system when the customer does not perform the appropriate operation to place an order after being seated at table A 800A.

S501 through S503 are similar to the operation described in FIG. 8B.

S513: The management server 100 determines that the table cannot be specified because only the child terminal ID (child terminal ID: 1) has been received.

S514: The management server 100 sends a warning and the child terminal ID (child terminal ID: 1) received at S513 to the parent terminal 200.

S515: When the parent terminal 200 receives the warning and the child terminal ID (child terminal ID: 1) from the management server 100, it sends the voice guidance command to the child terminal 400 indicated by the child terminal ID (child terminal ID: 1).

S516: When the child terminal 400 receives the voice guidance command, it provides voice guidance by the voice guidance unit 460. An example of the voice guidance is “Thank you for visiting our store. Please read QR on the table.” The child terminal 400 may generate a buzzing sound with the buzzer 470 or emit light with the light emitting unit 480 together with or instead of the voice guidance.

S517: The parent terminal 200 sends the warning to the terminal 300 with display.

S518: When the terminal 300 with display receives the warning from the parent terminal 200, it displays information on the display 340 indicating that the customer is not operating properly. By checking the display 340, the employee can recognize that the customer is not performing the proper operation.

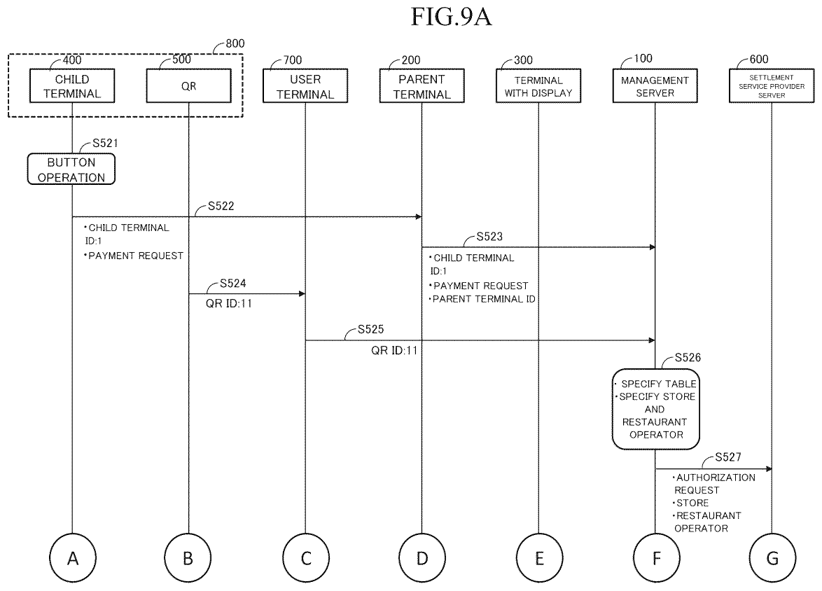

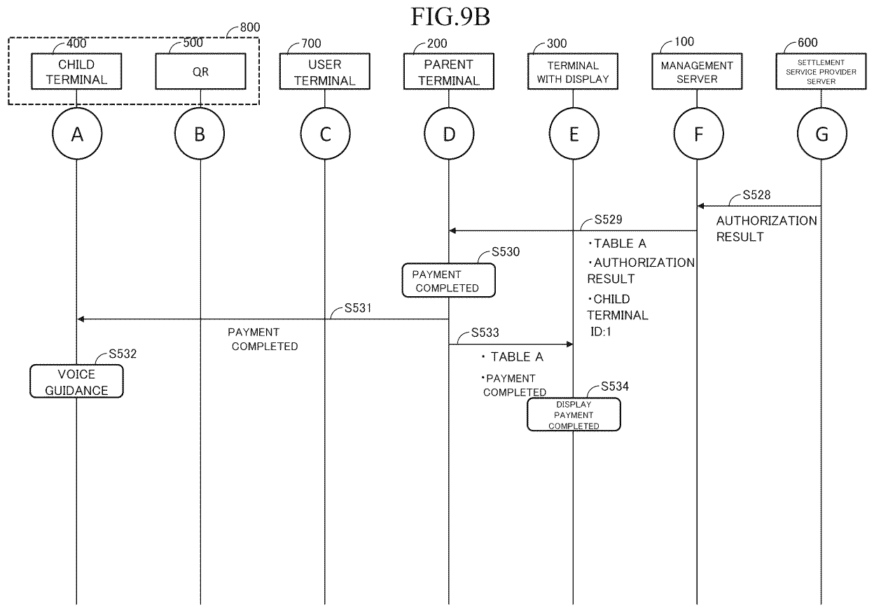

FIGS. 9A and 9B are sequence diagrams for explaining the operation of the table payment system when the customer makes payment for the food and beverage service received at the table A 800A. It should be noted that in FIGS. 9A and 9B, the operation of the table payment system is explained when the customer completes payment by performing an appropriate operation to make payment at the table 800A. The appropriate operation to perform the payment is the operation of the child terminal 400 (button operation) and the operation of reading the QR 500 by the user terminal 700.

S521: The button 450 on the child terminal 400 is operated by the customer.

S522: When the button 450 is operated, the child terminal 400 sends the child terminal ID (child terminal ID: 1) and a payment request to the parent terminal 200 (parent terminal ID: 100).

S523: When the parent terminal 200 receives the child terminal ID (child terminal ID: 1) and the payment request, it sends the child terminal ID (child terminal ID: 1), the parent terminal ID (parent terminal ID: 200) and the payment request to the management server 100.

S524: The user terminal 700 obtains QRID (QRID: 11) by reading QRID (QRID: 11) from QR11 500a.

S525: When the user terminal 700 obtains QRID (QRID: 11), it sends QRID (QRID: 11) to the management server 100.

S526: When the management server 100 receives the child terminal ID (child terminal ID: 1) and QRID (QRID: 11), it refers to the child terminal QR management information 112a to identify “the table identification information (table A), the store identification information (A) and the restaurant operator identification information (X)” corresponding to both of the child terminal ID (child terminal ID: 1) and QRID (QRID: 11).

S527: The management server 100 requests an authorization request to the settlement provider server 600. It should be noted that the authorization is a process to determine the acceptability of electronic payment with respect to a purchaser (user). When performing the authorization, the information required for the authorization (such as the store identification information and the restaurant operator identification information identified at S526) and the information required for the authorization received from the user terminal 700 (such as information identifying the user) are sent with the request from the management server 100.

S528: When the settlement provider server 600 receives the authorization request and the information necessary for the authorization from the management server 100, it performs the authorization and sends the authorization result (information indicating whether electronic settlement/payment is possible or not) to the management server 100.

S529: When the management server 100 receives the authorization result, it sends the table identification information (table A), the authorization result and the child terminal ID (child terminal ID: 1) to the parent terminal 200.

S530: When the parent terminal 200 receives the table identification information (table A), the authorization result and the child terminal ID (child terminal ID: 1), it completes the service settlement/payment (payment of charges for the service).

S531: When the parent terminal 200 completes payment for the service, it transmits the payment completion/completed (information indicating the completion of payment) to the child terminal 400 indicated by the child terminal ID (child terminal ID: 1).

S532: The child terminal 400 provides the voice guidance by the voice guidance unit 460. An example of the voice guidance is “Payment has been completed.” It should be noted that the child terminal 400 may generate the buzzing sound with the buzzer 470 or emit light with the light emitting unit 480 together with or instead of the voice guidance.

S533: The parent terminal 200 sends table identification information (table A) and payment completion/completed (information indicating payment completion) to the terminal 300 with display.

S534: When the terminal 300 with display receives the table identification information (table A) and the payment completion (information indicating the completion of payment) from the parent terminal 200, it displays information on the display 340 indicating that the payment has been completed at the table A 800A indicated by the table identification information. By checking the display 340, the employee can recognize that the payment for the food and beverage service provided to the customer at table A 800A has been completed.

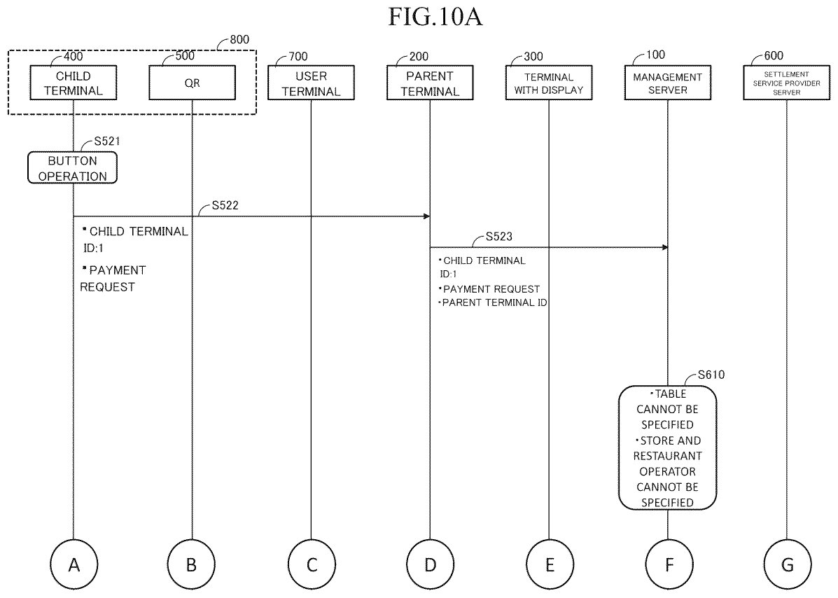

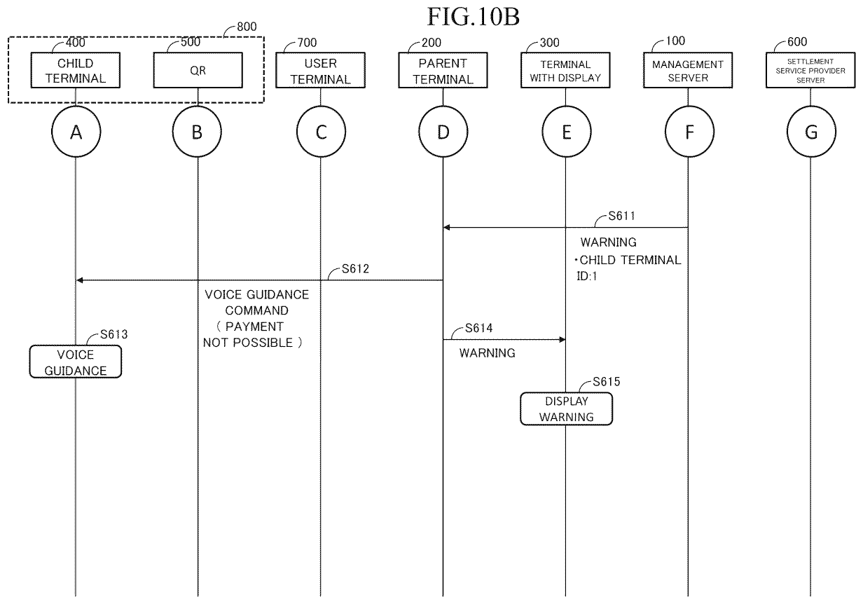

FIGS. 10A and 10B are sequence diagrams for explaining the operation of the table payment system when the customer makes payment for the food and beverage service received at the table A 800A. It should be noted that in FIGS. 10A and 10B, the operation of the table payment system is explained when the payment is not possible because the customer does not perform the appropriate operation to make payment at the table 800.

S521 through S523 are similar to the operation described in FIG. 9A.

S610: The management server 100 cannot identify the table identification information, the store identification information, and the restaurant identification information corresponding to both of the child terminal ID (child terminal ID: 1) and QRID by referring to the child terminal QR management information 112a because it has received only the child terminal ID (child terminal ID: 1) and has not received QRID. In this case, the management server 100 does not make the authorization request to the settlement provider server 600, and the payment is not possible.

S611: The management server 100 sends the warning and the child terminal ID (child terminal ID: 1) received at S611 to the parent terminal 200.

S612: When the parent terminal 200 receives the warning and the child terminal ID (child terminal ID: 1) from the management server 100, it commands the voice guidance to the child terminal 400 indicated by the child terminal ID (child terminal ID: 1).

S613: When the child terminal 400 receives the voice guidance command from the parent terminal 200, it provides the voice guidance. An example of the voice guidance is “Payment cannot be made. Please perform the payment operation again.” It should be noted that the child terminal 400 may generate the buzzing sound with the buzzer 470 or emit light with the light emitting unit 480 together with or instead of the voice guidance.

S614: The parent terminal 200 sends the warning to the terminal 300 with display.

S615: When the terminal 300 with display receives the warning from the parent terminal 200, it displays information on the display 340 indicating that payment cannot be made at the table A 800A.

As described above, the table payment system according to the first embodiment makes it possible to change the association/correspondence between the related information and QRID and the child terminal ID in the child terminal QR management information 112a held by the management server 100. This enables the restaurant side to use/reuse the same set of the child terminal 400 and QR 500 at the table 800 in the store simply by changing the associated information (table identification information) that is associated with the QRID and the child terminal ID, making it easy to change the table layout in the store and substitute the child terminal 400 and QR 500. The restaurant side can easily respond to changes in the number of child terminals 400 and QR 500 installed on the table 800.

Furthermore, even if the restaurant operator changes, the restaurant side can simply change the related information (restaurant operator identification information) that corresponds to the set of the child terminal 400 and QR 500, enabling the use/reuse of the set of the child terminal 400 and QR 500 by another restaurant operator, making it easy to respond to changes in restaurant operators.

Furthermore, even if the restaurant uses the child terminal 400 and QR 500 at a different store, the restaurant can simply change the related information (store ID) that corresponds to the set of the child terminal 400 and QR 500, allowing the child terminal 400 and QR 500 to be used at a different store. This makes it possible to easily respond to changes in stores where the child terminal 400 and QR 500 are used.

These effects are explained below, using Use Cases 1 through 5 as examples.

### <Use Case 1>

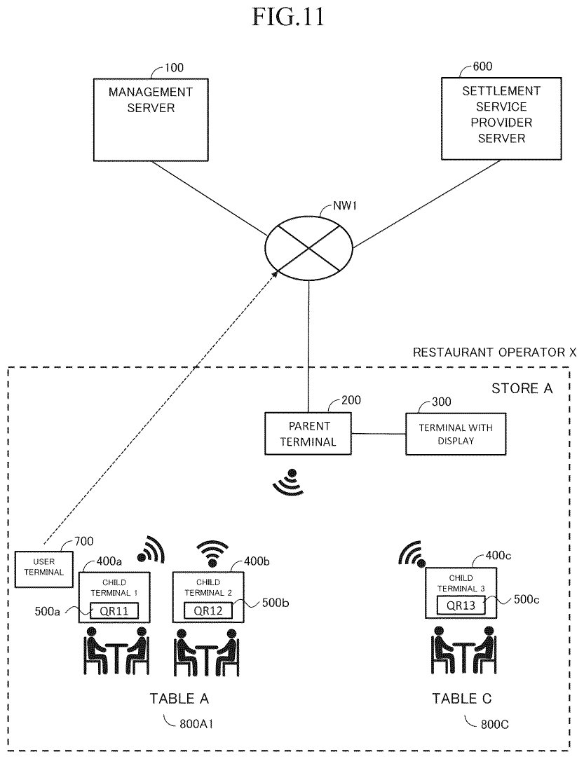

In the store A, the layout of the table 800 may be changed. For example, suppose that the layout of the table 800 shown in FIG. 1 is changed to the layout of the table 800 shown in FIG. 11. The layout of the table 800 shown in FIG. 11 combines the table A 800A and the table B 800B in FIG. 1 into one new table A 800A1. The layout of the table 800 shown in FIG. 11 the set of the child terminal 1 400a and QR11 500a and the set of the child terminal 2 400b and QR12 500b are installed on the new table A 800 A1. In other words, the set of the child terminal 2 400b and QR12 500b, which were installed in the table B 800B in FIG. 1, are used/reused in the new table A 800A1.

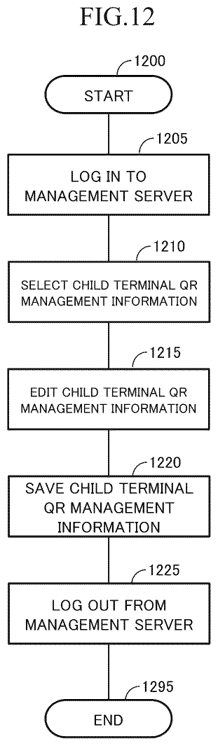

In this case, a modifier updates the child terminal QR management information 112a maintained by the management server 100 by entering an instruction to the management server 100 using the modifier's terminal (e.g., an administrator terminal (not shown)), as shown in the flowchart in FIG. 12.

Step 1205: The modifier logs in to the management server 100 by means of the modifier's terminal (e.g., the administrator terminal (not shown)) connected via the network NW1 with the management server 100.

Step 1210: The modifier inputs an instruction to the management server 100 via the modifier's terminal to select the child terminal QR management information 112a to be modified.

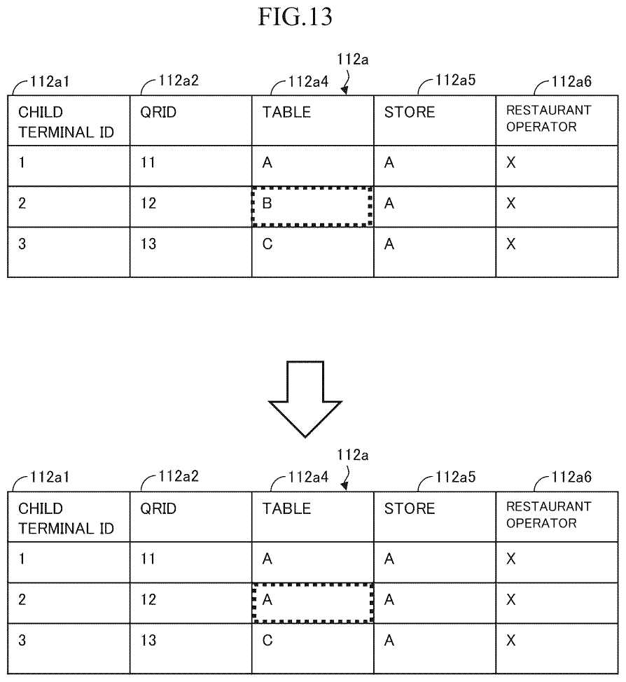

Step 1215: The modifier inputs an edit instruction for the child terminal QR management information 112a to be changed to the management server 100 via the modifier's terminal (not shown). In this example, as shown in FIG. 13, the management server 100 edits, in accordance with the edit instruction, the child terminal QR management information 112a so as to change the table identification information corresponding to the child terminal ID: 2 before the change from “B” to “A”.

Step 1220: The modifier inputs an instruction to save the edited child terminal QR management information 112a to the management server 100 via the modifier's terminal (not shown). The management server 100 saves the modified child terminal QR management information 112a in the storage device 110 of the management server 100 according to the instruction (child terminal QR management information 112a before modification is updated to the modified child terminal QR management information 112a). Step 1225: The modifier logs out of the management server 100 via the modifier's terminal (not shown).

Thus, when the restaurant side changes the layout of the table 800 shown in FIG. 1 to the layout of the table 800 shown in FIG. 11, the management server 100 simply updates the child terminal QR management information 112a according to the instructions input from the modifier's terminal, and the restaurant side can use/reuse the set of the child terminal 2 400b and QR12 500b that were installed at the table B 800B for the new table A 800A1. This allows the restaurant to easily respond to changes in the table layout.

### <Use Case 2>

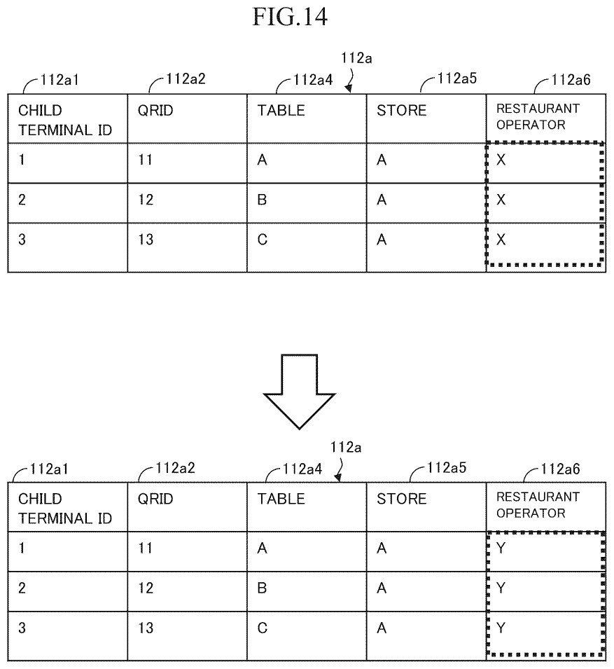

The restaurant operator that manages the store A may be changed. For example, suppose that the restaurant operator managing the store A is changed from the restaurant operator X shown in FIG. 1 to a restaurant operator Y. In this case, as shown in the flowchart in FIG. 12, the management server 100 updates the child terminal QR management information 112a according to the instructions input from the modifier's terminal. In the use case 2, the management server 100 edits the restaurant operator from “X” to “Y” at step 1215, as shown in FIG. 14.

In this way, when the restaurant operator changes from the restaurant operator X shown in FIG. 1 to the restaurant operator Y, the management server 100 only needs to update the child terminal QR management information 112a according to the instructions input from the modifier's terminal, and the multiple sets of the child terminal 400 and QR 500 installed at the table A 800A through the table C 800C can be used/reused by the new restaurant operator Y. This allows the restaurant side to easily respond to changes in restaurant operators.

### <Use Case 3>

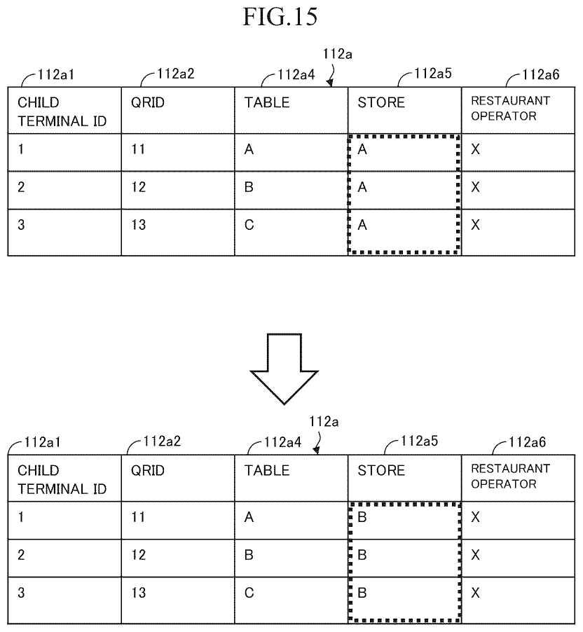

The store where the set of the child terminal 400 and QR 500 are used may be changed. For example, suppose that the store where the set of the child terminal 400 and QR 500 is used is changed from the store A shown in FIG. 1 to the store B. In this case, as shown in the flowchart in FIG. 12, the management server 100 updates the child terminal QR management information 112a according to the instruction input from the modifier's terminal. In the use case 3, the management server 100 edits the store to change from “A” to “B” at step 1215, as shown in FIG. 15.

In this way, when the restaurant changes the store where the multiple sets of child terminal 400 and QR 500 are used from the store A to the store B, the management server 100 only needs to update the child terminal QR management information 112a according to the instruction input from the modifier's terminal and the multiple sets of child terminal 400 and QR 500 that were used in the store A can be used/reused in the new store B. This allows the restaurant to easily respond to changes in the stores where sets of child terminal 400 and QR 500 are used.

### <Use Case 4>

The child terminal 400 and QR 500 may become unavailable. For example, suppose that at least one of the child terminal 400 and the QR 500 unavailable at the table A 800A shown in FIG. 1. In this case, suppose that a case occurs where the use of the table A 800A must be prioritized, such as when there is a customer who has reserved the table A 800A and the table B 800B is not planned to be used. In this case, the modifier installs the set of the child terminal 400 and QR 500 of the table B 800B at the table A 800A. As shown in the flowchart in FIG. 12, the management server 100 updates the child terminal QR management information 112a according to the instructions input from the modifier's terminal. In the use case 4, at step 1215, the management server 100 edits the table identification information corresponding to the child terminal ID: 2 before the change from “B” to “A” as shown in FIG. 13.

Thus, if at least one of the child terminal 400 and QR 500 becomes unavailable, the restaurant can easily substitute another child terminal 400 and QR 500 by simply having the modifier update the QR management information 112a.

### <Use Case 5>

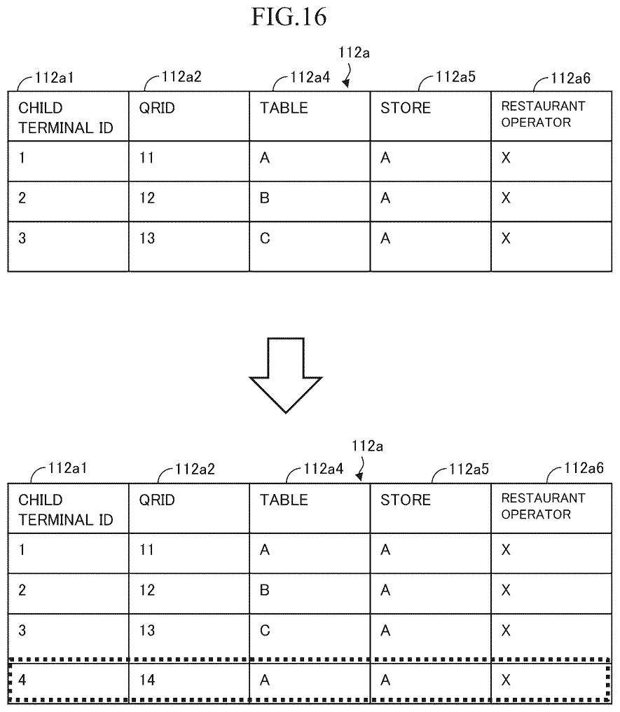

There are cases where two sets of the child terminal 400 and QR 500 are installed on one table 800. For example, suppose that two sets of the child terminal 400 and QR 500 are installed by adding one set of the child terminal 400 and QR 500 to the table A 800A shown in FIG. 1. In this case, as shown in the flowchart in FIG. 12, the management server 100 updates the child terminal QR management information 112a according to the instructions input from the modifier's terminal. In the use case 5, at step 1215, the management server 100 edits the child terminal QR management information 112a so as to add a record containing child terminal ID: 4, QRID: 14, table: A, store: A, and restaurant operator: X, as shown in FIG. 16.

In this way, in the case where the restaurant installs two child terminals 400 and QRs 500 on one table 800, the restaurant side can easily respond by simply having the modifier update the child terminal QR management information 112a.

### <Benefits of the System>

As described below, the table payment system according to the first embodiment has the advantage of significantly reducing the lead time for system installation compared to conventional technologies that require QRs to be installed on tables, which require embedding specific table identification information and other information. This effect is explained below using a use case 6 as an example.

### <Use Case 6>

In the table payment system according to the first embodiment, a plurality of sets of the child terminal 400 and QR 500 can be prepared in advance for provision to a restaurant operator. For example, when the table payment system is installed in the store A of the restaurant operator X, the required number of sets of the child terminal 400 and QR 500 are provided to the restaurant operator X from among the multiple sets of child terminal 400 and QR 500 prepared in advance. The table payment system can be put into operation simply by registering the identification information of the provided child terminals 400 and QRs 500 and the related information in the child terminal QR management information 112a. In the conventional technology, it is necessary to embed specific information in the QR according to the restaurant operator and the store where the system is to be introduced. In the table payment system according to the first embodiment, there is no such need. In the table settlement system according to the first embodiment, it is only necessary to register the child terminal ID of the child terminal 400 and the QRID of the QR 500 and related information in the child terminal QR management information 112a.

For example, when the table payment system is installed in a store of a restaurant operator different from the restaurant operator X, the required number of sets of the child terminal 400 and QR 500 are provided to another restaurant operator from among the multiple sets of the child terminal 400 and QR 500 prepared in advance. In such a case, the table payment system can still be operated simply by registering the child terminal IDs of the provided child terminals 400 and QRIDs of the QRs 500 and the related information in the child terminal QR management information 112a.

### <Effect>

As explained above, the table payment system according to the first embodiment allows the customer to order food and beverage service offerings and make payments for food and beverage services without contact with employees at locations where the child terminal 400 and QR 500 are installed.

In the table payment system according to the first embodiment, the child terminals 400 and QRs 500 are installed at arbitrary locations (table A 800A through table C 800C in the example in FIG. 1), and multiple pieces of table identification information indicating the arbitrary location (table 800) where they are installed are associated with each of information of the installed child terminals 400 and QRs 500 in the child terminal QR management information 112a. Furthermore, the table payment system makes it possible to change the association/correspondence between the related information, the QRID, and the child terminal ID that are held by the management server 100. As a result, the table payment system can reuse the set of the child terminal 400 and QR 500 at the table 800 in the store only by changing the related information (table identification information) associated with the QRID and the child terminal ID. Therefore, the table payment system can easily respond to changes in the table layout in the store, substitution of child terminal 400 and QR 500, changes in the number of child terminals 400 and QRs 500 installed at the table 800, and the like.

Furthermore, in the table payment system, even if the restaurant operator that manages/operates the store changes, the related information (restaurant operator identification information) associated with the set of the child terminal 400 and QR 500 is only changed, and the set of the child terminal 400 and QR 500 can be used/reused by another restaurant operator. As a result, the table payment system can easily respond to changes in restaurant operators.

Furthermore, even if the child terminal 400 and the QR 500 are used in another store, the table payment system only changes the related information (store identification information) associated with the set of the child terminal 400 and the QR 500. As a result, the table payment system can easily respond to changes in stores using the child terminal 400 and the QR 500.

The table payment system according to the first embodiment can significantly reduce the lead time of system introduction compared to the conventional system, In the conventional system, specific table information needs to be embedded in QR installed on the table.

### Second Embodiment

The table payment system according to the second embodiment of the present invention will be described. The table payment system according to the second embodiment differs from the table payment system according to the first embodiment only in that the child terminal 400 and QR 500 are installed separately on the table 800, as shown in FIG. 17.

The following explanation focuses on these differences.

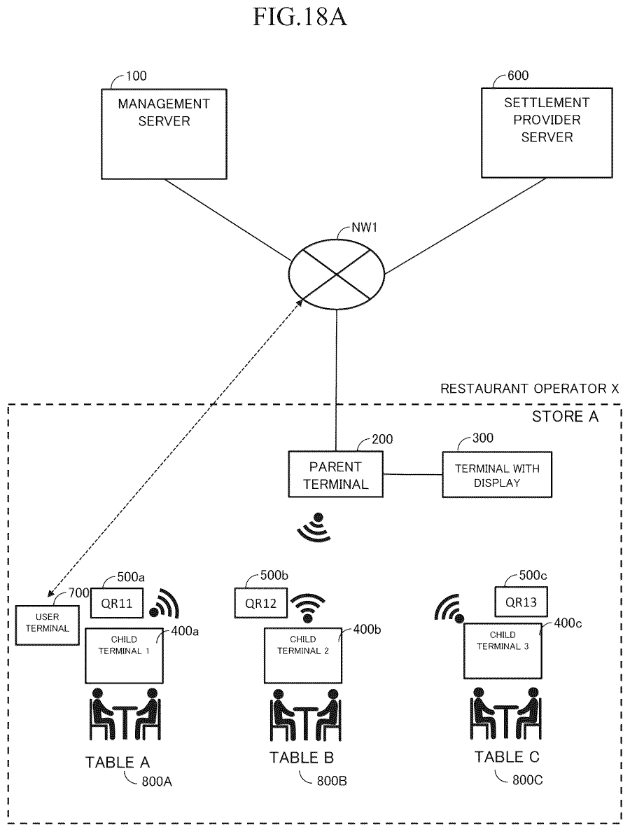

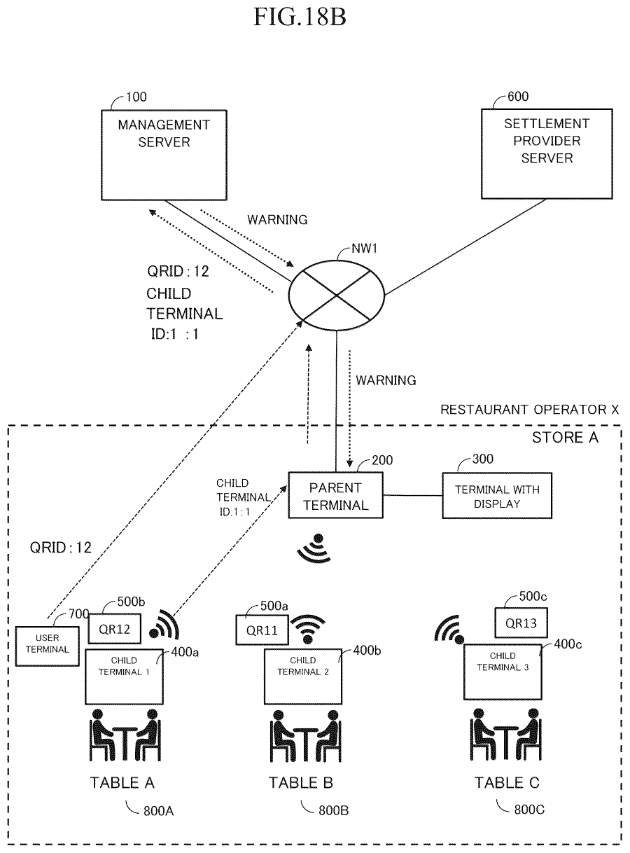

FIG. 18A shows an example configuration of the table payment system according to the second embodiment. As shown in FIG. 18A, in the table payment system, the child terminal 400 and QR 500 are installed separately on the table 800.

In a case where the child terminal 400 and the QR 500 are installed separately on the table 800, the QR 12 500b is moved to the table A 800A and the QR 11 500a is moved to the table B, due to mischief or employee negligence. As a result, a state may occur where the QR12 500b and the QR11 500a are not installed on the correct table 800.

In this case, in the table payment system, when the customer is seated at the table A and operates the child terminal 400, the child terminal 400 sends the child terminal ID 1 to the management server 100 via the parent terminal 200. When the user terminal 700 reads the QR 12 500b, the QRID (QRID: 12) is transmitted to the management server 100.

The management server 100 determines that because there is no correspondence information (record) in the child terminal QR management information 112a in FIG. 3B that corresponds to both of the received child terminal ID (child terminal ID: 1) and QRID (QRID: 12), any of the QR12 500b and the child terminal 1 400a are not placed in the correct table 800 (installation is determined to be faulty). In this case, the management server 100 sends a warning to the parent terminal 200. When the parent terminal 200 receives the warning, it displays the warning that the installation failure of the QR 12 500b and the child terminal 1 400a has occurred on the display 340 of the terminal 300 with display.

By reviewing the warning on the display 340, the employee can recognize that any of the QR12 500b and the child terminal 1 400a are not placed on the correct table 800 and can take action to correct the faulty installation.

### <Effect>

As explained above, the table payment system according to the second embodiment of the present invention has the same effects as the first embodiment. Furthermore, the table payment system according to the second embodiment can inform the employee of faulty installation of the child terminal 400 and QR 500 due to tampering or the employee negligence.

### <<Variant Example>>

The present invention is not limited to the above embodiments, and various variations can be adopted within the scope of the present invention. Furthermore, each of the above embodiments can be combined with each other as long as they do not depart from the scope of the present invention. In each of the above embodiments, the store may be a mobile store.

In each of the above embodiments, the child terminal 400 may be equipped with two buttons and one button of two buttons is used at entering a store and taking a seat the other button two buttons is used for payment. In this case, the button used at entering the store and taking the seat is operated as the operation of the child terminal 400 when the customer enters the store and is seated at the table 800, and the button for payment is operated as the operation of the child terminal 400 when the customer makes a payment.

In each of the above embodiments, QR 500 used at entering the store and taking the seat and QR 500 for payment may be installed along with the child terminal 400. QR 500 used at entering the store and taking the seat needs to be read by the user terminal 700 of the customer when the customer enters the store and is seated. QR 500 for payment needs to be read by the user terminal of the customer at the time of payment.

In the second embodiment described above, a matching determination may be performed to determine if the child terminal 400 and QR 500 are poorly installed. As already mentioned, when the child terminal 400 and QR 500 are installed separately on the table 800, faulty installation of the child terminal 400 and QR 500 may occur due to tampering or employee negligence. In the matching determination, a determination is made as to whether the child terminal ID from the parent terminal 200 and the QRID from the user terminal 700 have been obtained, and the correspondence between the child terminal ID obtained from the parent terminal 200 and the QRID obtained from the user terminal 700 is matched. The matching of the correspondence means checking whether the child terminal ID and the QRID are associated in the child terminal QR management information 112a. Specifically described, in the matching of the correspondence between the child terminal ID and the QRID, the terminal ID management information 112a is referenced to identify the QRID corresponding to the child terminal ID obtained from the parent terminal 200, and it is determined whether the identified QRID and the QRID obtained from the user terminal 700 are identical. When the identified QRID and the QRID obtained from the user terminal 700 match, the management server 100 determines that the matching is successful, and when the identified QRID and the QRID obtained from the user terminal 700 do not match, the management server 100 determines that the matching is unsuccessful/failure. In the matching of the correspondence between the child terminal ID and the QRID, the child terminal ID corresponding to the QRID may be identified from the QRID obtained from the user terminal 700 by referring to the child terminal QR management information 112a, and whether or not the identified child terminal ID matches the child terminal ID obtained from the parent terminal 200 may be determined. When the matching fails, the management server 100 determines that any of the QR12 500a and the child terminal 1 400a are not placed in the correct table 800 (faulty installation) and sends a warning to the parent terminal 200. When the parent terminal 200 receives the warning, it displays the warning that the installation failure of the QR 12 500a and the child terminal 1 400a has occurred on the display 340 of the terminal 300 with display.

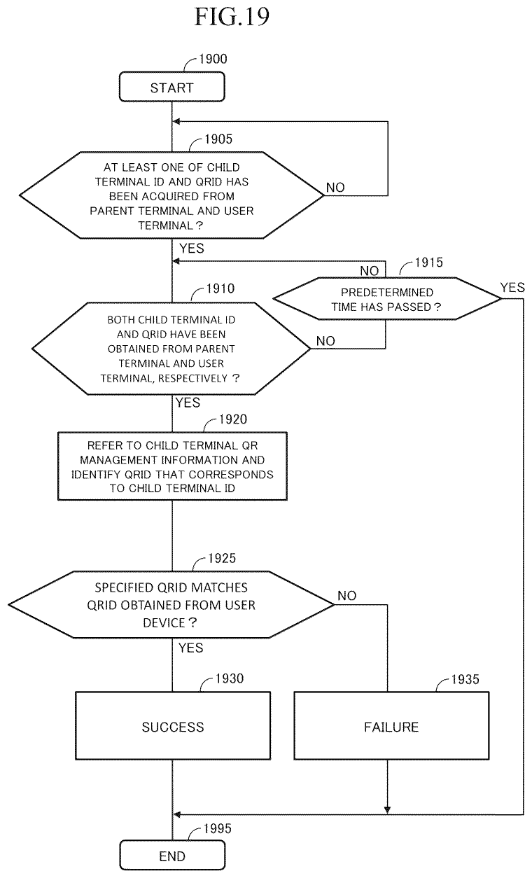

FIG. 19 is a flowchart for explaining the matching determination performed by the management server 100. The matching determination is performed, for example, at S506 in FIG. 8A, S513 in FIG. 8B, S526 in FIG. 9A, and S610 in FIG. 10A. The management server 100 starts the process at step 1900 and proceeds to step 1905 to determine whether or not it has already obtained at least one of the child terminal ID from the parent terminal 200 and the QRID from the user terminal 700. When neither the child terminal ID nor the QRID has been obtained, the management server 100 makes a “NO” determination at step 1905 and performs the process of step 1905 again. When at least one of the child terminal ID and QRID has already been obtained, the management server 100 makes a “YES” determination at step 1905 and proceeds to step 1910. The management server 100 proceeds to step 1910 to determine whether or not both the child terminal ID and the QRID have already been obtained. When both the child terminal ID and the QRID have not been obtained, the management server 100 makes a “NO” determination at step 1910 and proceeds to step 1915 to start measuring time and determine whether or not the measured time exceeds the predetermined time (that is, whether or not the predetermined time has passed after obtaining either the child terminal ID or the QRID). When the measurement time is less than or equal to the predetermined time, the management server 100 makes a “NO” determination at step 1915, returns to step 1910, and again executes the processing of step 1910 as previously described. When both the child terminal ID and QRID have already been obtained, the management server 100 makes a “YES” determination at step 1910 and proceeds to step 1920. The management server 100 proceeds to step 1920 to identify the QRID corresponding to the child terminal ID by referring to the child terminal ID management information 112a. The management server 100 then proceeds to step 1925 to determine whether or not the QRID identified at step 1920 matches the QRID obtained from the user terminal 700. When the QRID identified at step 1920 and the QRID obtained from the user terminal 700 match, it can be said that the child terminal 400 and the QR 500 from which the user terminal 700 obtained the QRID correspond. Therefore, in this case, the management server 100 makes a “YES” determination at step 1925 and proceeds to step 1930 to determine success and proceeds to step 1995 to temporarily terminate the matching determination. When the QRID identified at step 1920 does not match the QRID obtained from the user terminal 700, it can be said that the child terminal 400 that sent the payment request does not correspond to the QR 500 from which the user terminal 700 obtained the QRID. Therefore, in this case, the management server 100 makes a “NO” determination at step 1925 and proceeds to step 1935, determining failure and proceeding to step 1995 to temporarily terminate the matching determination. For example, when only an operation (button operation) is performed to make a payment request to the child terminal 400 or only an operation to read information from QR 500 by the user terminal 700, after one of the child terminal ID and QRID is obtained (“YES” at step 1905), the other one of the child terminal ID and QRID may not be obtained. In this case, the management server 100 repeats “NO” at the processing of step 1910 and “NO” at the processing of step 1915 described above until the predetermined time elapses after any of the child terminal ID and QRID are obtained, and when the predetermined time elapses, it makes a “YES” determination at step 1915 and proceeds to step 1995 to terminate temporarily. According to this variant example, the pair management of the child terminal 400 and the QR 500 (alerting when the pair collapses) mainly prevents installation defects and enables stable system operation in restaurants.

In each of the above embodiments, the table payment system may perform a matching decision by the management server 100 to determine whether or not the payment request is appropriate, and when the matching is successful, payment is possible (i.e., the system makes an authorization request and proceeds with the processing necessary for settlement to enable settlement by the parent terminal 200). Thereby, the table payment system for each embodiment can prevent unauthorized settlement.

In each of the above embodiments, the terminal 300 with display may be a smartphone or tablet used by employees.

### REFERENCE SIGNS LIST

100: management server
110: storage device
111: program
112: database
112a: child terminal QR management information
112b: parent-child terminal management information
112c: menu information
120: memory
130: CPU
140: input/output interface
150: network interface
160: bus
200: parent terminal
300: terminal with display
400: child terminal
500: QR
600: settlement provider server
700: user terminal

1. A table payment system comprising:
a parent terminal;
a plurality of child terminals capable of wirelessly communicating with the parent terminal in a power saving manner;
a plurality of information storage media installed on a table together with the child terminal; and
a management server capable of communicating with the parent terminal and a user terminal via a network, the management server comprising a storage device,
wherein,
the management server stores management information in the storage device, the management information including multiple pieces of correspondence information in which child terminal identification information for identifying the child terminal, information storage medium identification information for identifying the information storage medium installed on the table together with the child unit, and related information that is information related to the child terminal and the information storage medium are associated with each other; and
the management server is capable of changing an association of the correspondence information.

2. The table payment system according to claim 1,
wherein,
the management server receives:
information transmitted from the child terminal via the parent terminal based on operation of the child terminal by the customer; and
information transmitted from the user terminal based on reading operation of the information storage medium by the user terminal of the customer; and
performs, using the received information, a process for receiving a service at the table where the customer is seated, and a process for making a payment for the service received by the customer at the table.

3. The table payment system according to claim 1,
wherein,
the related information includes table identification information indicating the table where the child terminal and the information storage medium are installed; and
the management server changes, when the table in which a set of the child terminal and the information storage medium is installed is changed, the table identification information associated with the child terminal identification information and the information storage medium identification information to the table identification information indicating the changed table, in accordance with an instruction input to the management server.

4. The table payment system according to claim 1,
wherein,
the related information includes store identification information indicating a store where the plurality of the child terminals and the plurality of the information storage media are installed; and
the management server changes, when the store in which the set of the child terminals and the information storage media are installed is changed, the store identification information associated with the child terminal identification information and the information storage medium identification information to the store identification information indicating the changed store, in accordance with an instruction input to the management server.

5. The table payment system according to claim 1,
wherein,
the related information includes restaurant operator information indicating a restaurant operator that operates a store where the plurality of the child terminals and the plurality of the information storage media are installed; and
the management server changes, when the store where the restraint operator operates is changed, the restaurant operator identification information associated with the child terminal identification information and the information storage medium identification information to the restaurant operator identification information indicating the changed restaurant operator in accordance with an instruction input to the management server.

6. The table payment system according to claim 1,
wherein,
the parent terminal receives the child terminal identification information from the child terminal to send the received child terminal identification information to the management server; and
the management server receives the child terminal identification information from the parent terminal, receives the information storage medium identification information that the user terminal reads from the information storage medium by communication from the user terminal, and specifies the related information associated with the received child terminal information and the information storage medium identification information based on the management information.

7. The table payment system according to claim 3, further comprising a terminal with display that is communicably connected to the parent terminal and has a display capable of displaying images,
wherein,
the child terminal includes an operation device;
the child terminal transmits the child terminal identification information to the parent terminal when a customer enters the store, sits at the table at which the child terminal is installed, and operates the operation device of the child terminal;
the parent terminal transmits, when receiving the child terminal identification information, the child terminal identification information to the management server;
the management server receives the child terminal identification information from the parent terminal, receives the information storage medium identification information read by the user terminal from the information storage medium through communication from the user terminal, and transmits, when the management server is able to specify the table identification information associated with the received child terminal identification information and the received information storage medium identification information based on the management information, the specified table identification information and the child terminal identification information to the user terminal and the parent terminal;
the parent terminal transmits a guidance command to the child terminal indicated by the child terminal identification information and transmits the specified table identification information received from the management server to the terminal with display; and
the terminal with display displays on the display information indicating that the customer is present at the table indicated by the table identification information.

8. The table payment system according to claim 1, further comprising a terminal with display that is communicably connected to the parent terminal and has a display capable of displaying images,
wherein,
the child terminal includes an operation device;
the related information includes table identification information indicating the table where the child terminal and the information storage medium, store identification information indicating a store where the plurality of the child terminals and the plurality of the information storage media are installed, and restaurant operator information indicating a restaurant operator that operates the store where the plurality of the child terminals and the plurality of the information storage media are installed;
the child terminal transmits, when the customer who has received a service at the table where the child terminal is installed operates the operation device of the child terminal, the child terminal identification information and a payment request to the parent terminal;
the parent terminal transmits, when receiving the child terminal identification information and the payment request, the child terminal identification information and the payment request to the management server;
the management server makes, when the management server is able to specify the table identification information, the store identification information, and the restaurant operator identification information associated with the received child terminal identification information and the received information storage medium identification information based on the management information, an authorization request to a settlement service provider server, receives an authorization result from the settlement service provider server, and transmits the authorization result, the identified table identification information, and the identified child terminal identification information to the parent terminal;
the parent terminal transmits information indicating completion of the payment and a guidance command to the child terminal indicated by the child terminal identification information based on the authorization result, and transmits the specified table identification information received from the management server to the terminal with display; and
the terminal with display displays on the display information indicating that the payment for the table identified by the table identification information has been completed.

9. The table payment system according to claim 1, further comprising a terminal with display that is communicably connected to the parent terminal and has a display a display capable of displaying images,
wherein,
the parent terminal receives the child terminal identification information from the child terminal and transmits the received child terminal identification information to the management server;
the management server receives the child terminal identification information from the parent terminal and receives the information storage medium identification information read by the user terminal from the information storage medium through communication from the user terminal;
the management server transmits, when the correspondence information associated with the received child terminal identification information and the received information storage medium identification information is not present, a warning that the information storage medium and the child terminal are not properly installed to the parent terminal; and
the terminal with display displays on the display the warning that the information storage medium and the child terminal are not properly installed.

10. The table payment system according to claim 1, further comprising a terminal with display that is communicably connected to the parent terminal and has a display capable of displaying images,
wherein,
the parent terminal receives the child terminal identification information from the child terminal and transmits the received child terminal identification information to the management server;
the management server receives the child terminal identification information from the parent terminal and receives the information storage medium identification information read by the user terminal from the information storage medium through communication from the user terminal;
the management server transmits, when checking correspondence between the received child terminal identification information and the information storage medium identification information, and determining that the check fails, a warning that the information storage medium and the child terminal are not properly installed to the parent device; and
the terminal with display displays on the display the warning that the information storage medium and the child unit are improperly installed.

11. A table payment method executed by:
a parent terminal;
a plurality of child terminals capable of wirelessly communicating with the parent terminal in a power saving manner;
a plurality of information storage media installed on a table together with the child terminal; and
a management server capable of communicating with the parent terminal and a user terminal via a network, the management server comprising a storage device,
the table payment method including storing management information in the storage device by the management server, the management information including multiple pieces of correspondence information in which child terminal identification information for identifying the child terminal, information storage medium identification information for identifying the information storage medium installed on the table together with the child unit, and related information that is information related to the child terminal and the information storage medium are associated with each other, an association of the correspondence information being capable of being changed by the management server.
